(19) United States
(12) Patent Application Publication
(10) Pub. No.: US 2006/0240880 A1
(43) Pub. Date: Oct. 26, 2006

(54) Single hand cellular flip phones opener

(76) Inventor: Ted Freeman, Anaheim, CA (US)

Correspondence Address: TED FREEMAN, 2858 W. BALL RD. AP.E-3, ANAHEIM, CA, 92804, US

(21) Appl. No.: 11/113,724

(22) Filed: Apr. 26, 2005

(51) Int. Cl. H04M 1/00

(52) U.S. Cl. 455/575.3; 455/575.1

(57) ABSTRACT

The Single Hand Flip Phone Opener is mechanical attachment to cellular flip-phones, which makes possible for the user of such a phone to open the phone with one hand. The invention is based on the fact that big percent of the cellular phones are flip-type and operating that type phones demands use of both hands for opening the phone. Using both hands for opening of flip phone very often is not only inconvenient, but also outright dangerous, especially by driving. With the presented devise the inconvenience and danger of operating cellular flip-phone during driving and other activities that demand one hand use, will be eliminated.

The presented invention—Single Hand Cellular Flip Phones Opener—is mechanical attachment, which makes possible to open flip-phones single-handedly. The popularity of cellular phones in recent years had come to the point, in which the cellular phones are used by any circumstances. The flip-cellular phones despite their widely use have a major inconvenience, they required both hands for opening for operating. This major inconvenience becomes real danger in situation when a car driver uses the cellular flip-phone. The present invention eliminates the need of second human hand for opening the flip-phone. The invention is simple to operate, does not need maintenance and is possible to be manufactured as separated or incorporated in the flip-phone body.

### CROSS-REFERENCE TO RELATED APLICATIONS

Not-Applicable.

### STATEMENT REGARDING FEDERALLY SPONSORED RESEARCH OR DEVELOPMENT

Not-Applicable.

### REFERENCE TO SEQUENCE LISTING OR COMPUTER PROGRAM LISTING COMPACT DISK APPENDIX

Not-Applicable.

### BACKGROUND OF THE INVENTION

The present flip-phones despite their variety by brand, manufacturers or models have one common operational problem. The phones need two hands for opening. This problem is causing major inconvenience for people engaged in different activities involving continuous use of one hand. Special attention on the problem is to be paid especially in the highly passenger-car-dependable-transportation society, where using both hands to operate flip-phone during driving is extremely dangerous. The invention is intended to make possible opening of flip-phones by single hand use.

### BRIEF SUMMARY OF THE INVENTION

The invention makes possible to eliminate the use of second hand for opening the flip-type cellular phones. The presented invention is simple mechanical attachment for cellular flip-phones, which could be manufactured as separated or incorporated in the body of the phone. The invention basically uses as a levering point already existing axis of the cellular flip-phone hinge. The attachment had two parts. Moving metallic Wire Brace (FIG. 2) and fixed to the front of the phone unmoving metallic Base Plank (FIG. 3). The Wire Brace rotates at 180 degree hinged on Base Plank using two connecting tubing housings. The Wire Brace has two positions, a folded (retracted) position and an extended position. Folded position is “non-use” position, in which the Wire Brace is positioned flat to the body of the phone. In “use” position the Wire Brace extends by rotation beyond the flipping hinge of the flip-phone creating a leverage which can be used to open the phone with the index finger of one hand. The phone can be used with both extended and not extended Wire Brace, since the Brace does not interfere with using the phone in case two hands opening of the phone is intended. Moving from “non-use” to “use” position of the Wire Brace is by one finger, facilitated by the use of spring action of the Brace.

Note: The prototype is experimented by using the separated Opener attached to regular cellular flip-phone.

### BRIEF DISCRIPTION OF THE SEVERAL VIEWS OF THE DRAWINGS

FIG. 1. Assembled Single Hand Flip Phone Opener. The figure represents the view of the Opener, Wire Brace is inserted in the hinging two tubing housings of the Base Plank.

FIG. 2. Part #1, Wire Brace. The figure represents the view of the Wire Brace.

FIG. 3. Part #2, Base Plank. The figure represents the view of the Base Plank.

FIG. 4a. View of flip-phone with mounted Opener in folded (“non-use”) position.

FIG. 4b. View of flip-phone with mounted Opener in extended (“use”) position.

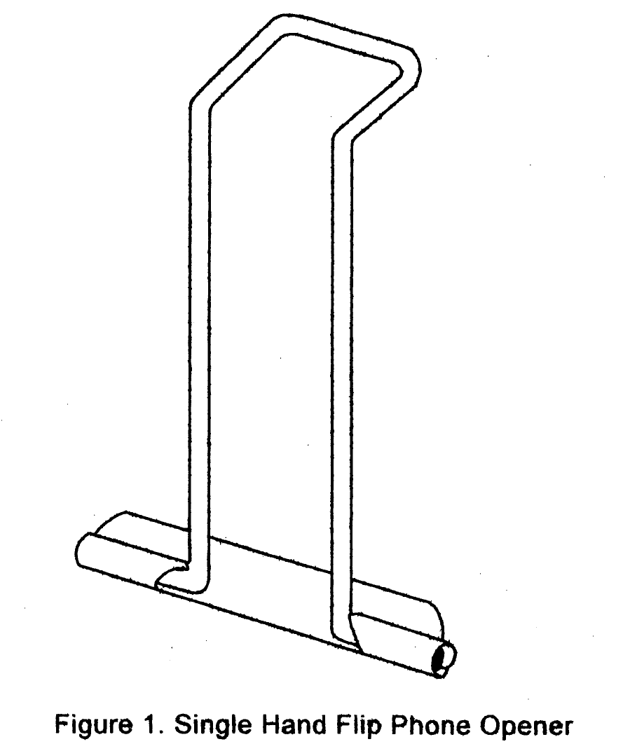

### DETAILED DESCRIPTION OF THE INVENTION

The presented invention is mechanical attachment intended for use mounted on cellular flip-type phones. It makes possible the opening of flip-phones by using single hand instead of two hands. The invention could be of substantial facilitation by driving car users, which suffer of great distraction trying to open the cellular flip-phones during driving. The operational idea for the attachment is to provide lever, which to be used for lifting the upper part of the flip-phone with the index finger of the hand, while holding the phone with the same hand. Since the levering axes itself already exist on every flip-phone, (that is the hinge connecting the two flipping parts of the flip-phone), the attachment is very simple for manufacturing and operating.

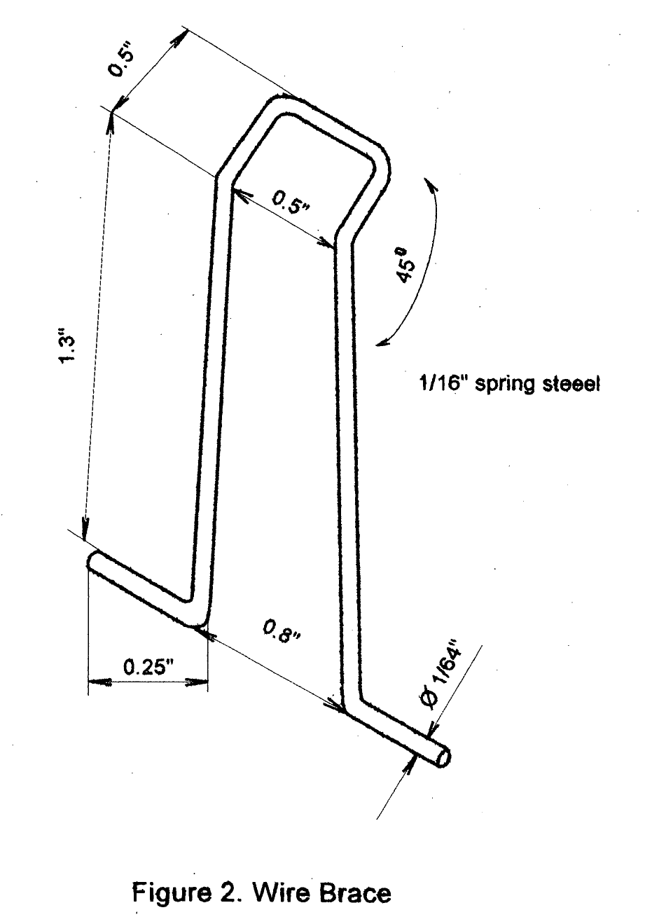

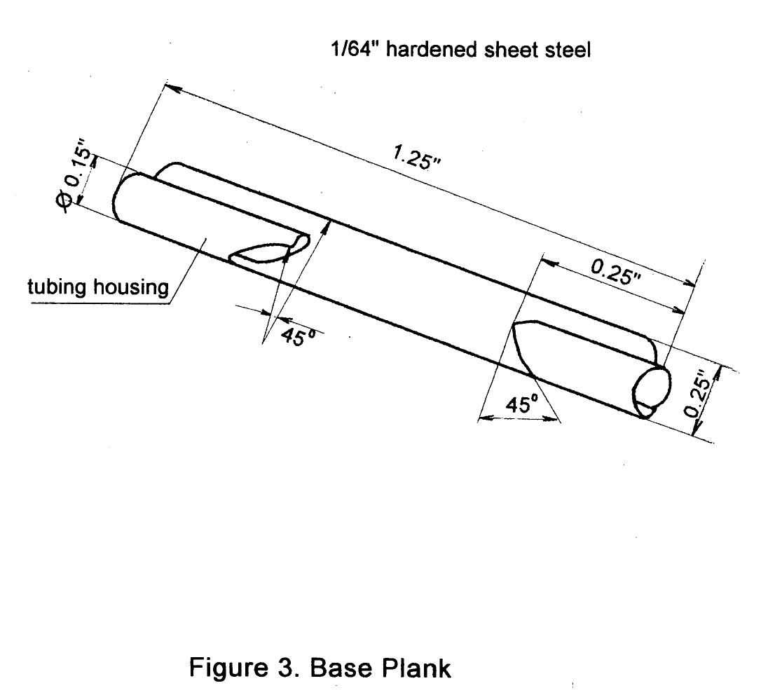

Two parts construct the invention. Metal Wire Brace and metal Base Plank. The Wire Brace is manufactured from spring steel wire, thickness around 1/16″. (The thickness of the wire is not critical.) The metal Base Plank is manufactured of hardened sheet steel, thickness around 1/64″. (The thickness of the Base Plank is not critical.) The Wire Brace is attached to the Base Plank via two tubing housings, which hold loose the inserted ends of the Wire Brace. The Wire Brace's ends are bended slightly outwards before being inserted in the tubing housing of the Base Plank in order to create tension in the Brace as seen on FIG. 2. The inside ends of the two tubing housings are manufactured with cut of 45 degree and the sharp point ends are displaced at 45 degree regarding the base, that way creating only two static lock positions for the Brace. The positions are: “non-use”, with the Brace locked flat to the phone body, and “use”, with the Brace rotated to the extended lock position, ready to be pressed by index finger for flip-phone opening. All other position of the Brace between those two lock “end” positions are unstable and if the Brace is rotated and let go it will lock automatically in “end” position because of the spring action of the Brace directed by tubing housings.

The Single Hand Flip Phone Opener is operating as follows: 1/Holding the flip-phone with one hand the user pushes the Wire Brace rotating it till it locks in “use” position. 2/The user then uses his index finger to press the upper part of the Wire Brace causing the top part of the flip-phone to open.

If the Wire Brace is left in unfolded, “use” position, there is no need for pushing as given in 1/.

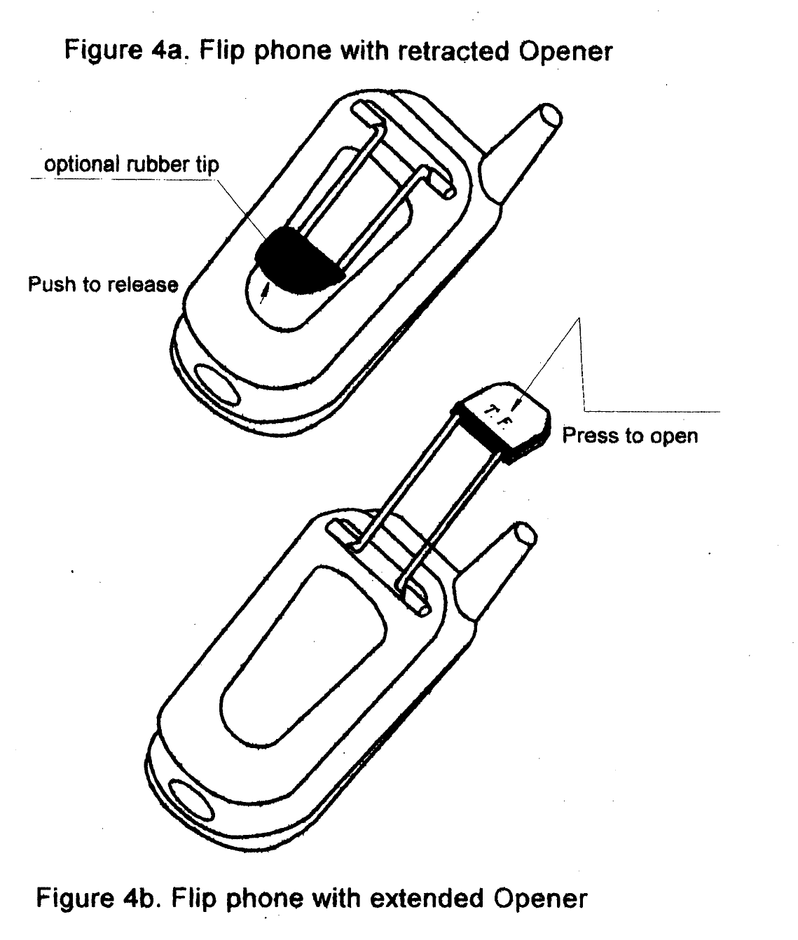

Note: The active “push” end of the Opener can be covered with rubber or plastic cap for better handling or decoration as shown on FIG. 4a and FIG. 4b.

1. The Single Hand Flip Phone Opener is facilitating flip-phone operating and is making safer operating cellular flip-phone during car driving or other activities. It major benefit is contributing to the safety of the user via limiting the handling attention to the cellular flip-phone, which a person needs when placing or receiving calls. The safety is achieved by eliminating the need of use of second hand for opening of a cellular flip-phone.
